(19) United States
(12) Patent Application Publication
(10) Pub. No.: US 2025/0262550 A1
(43) Pub. Date: Aug. 21, 2025

(54) Real Time War Strategy Application Game

(71) Applicant: David White, Livingston, TX (US)

(72) Inventor: David White, Livingston, TX (US)

(21) Appl. No.: 19/054,850

(22) Filed: Feb. 16, 2025

Related U.S. Application Data
(60) Provisional application No. 63/554,301, filed on Feb. 16, 2024.

(51) Int. Cl. A63F 13/822

(52) U.S. Cl. CPC A63F 13/822

(57) ABSTRACT

The End of Days WW III is the only application developed specifically to offer an alternative real-time strategy game that permits players to pay for access, at their leisure. The End of Days WW III is uniquely designed with diverse virtual features, cutting-edge technology to ensure complete functionality, a sleek gamer interface and it is intended to be a multilingual app offering selections for: English, German, Italian, French, Russian, Chinese, and Japanese, along with other primary languages, across the globe.

### BACKGROUND

Gaming is a growing industry that caters to casual players, avid players and professional competitive players, alike. With such vast consumer engagement there is ample opportunity for innovation. There have been no products available as original equipment or as an aftermarket to address this problem.

An innovative real time strategic app game with an innovative war theme, is not being met by any known device or system at present. There have been no products available as original equipment or as an aftermarket to address this problem either.

### SUMMARY OF THE INVENTION

The main purpose of the Real Time War Strategy App Game is to provide users with a new and realistic gaming option possessing a war theme.

The Real Time War Strategy Application Game includes a world map comprising countries and cities and terrain of the world, past and present, according to a chosen game epoch. Military base cards representing military bases include past and present and fictional bases according to the chosen epoch. The disclosed game also includes a plurality of player tokens representing military figures, past and present and fictional according to the chosen epoch. The disclosed game additionally includes campaign cards representing a particular battle documented from the chosen epoch and optionally a fictional battle. The disclosed game further includes resource tokens each configured to represent a quanta of industrial strength, an economic strength, a political strength and a military strength and a fictional strength. The game yet includes a plurality of technology tokens each configured to represent a quanta of research and development strength of the particular military figure and his country and his epoch.

### BRIEF DESCRIPTION OF THE DRAWINGS

FIG. 1 is a block chart of the Real Time War Strategy Application Game in accordance with an embodiment of the present disclosure.

FIG. 2 is a flow chart of the Real Time War Strategy Application Game in accordance with an embodiment of the present disclosure.

FIG. 3 is a game map including tokens and cards in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

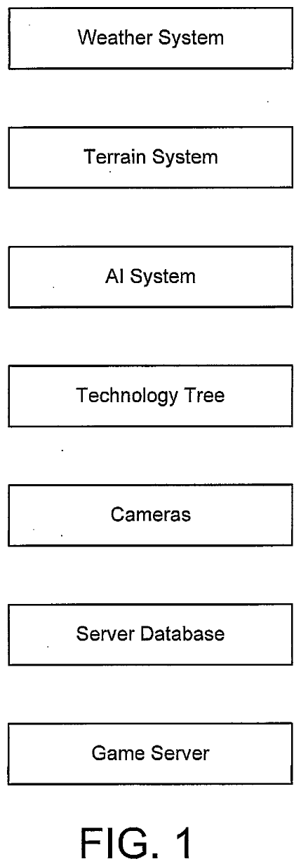

FIG. 1 is a block chart view of the Real Time War Strategy Application Game showing in accordance with an embodiment of the present disclosure. The view includes the weather system, the terrain system, the AI system, the technology tree, the cameras, the server database and the game server. The cameras are employed for realization from picture augmentation of a successful campaign given a start and a finish to create a supposition of one victorious player.

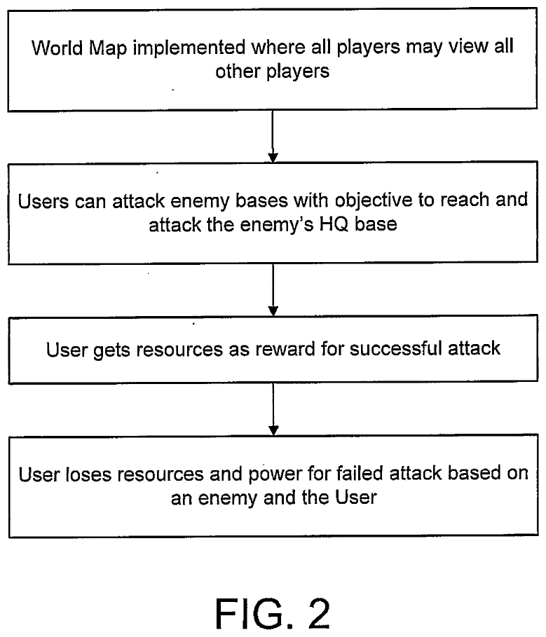

FIG. 2 is a flow chart of the Real Time War Strategy Application Game in accordance with an embodiment of the present disclosure. The flow chart includes the implementation of the world map where all players may view all other players. It also includes users attacking enemy bases with an objective to reach and attack the enemy's headquarters base. It also includes the successful attacker getting the resources of the loser as a reward in skill points. It also includes losing skill points and resources and losing power for a failed attack based on an enemy user.

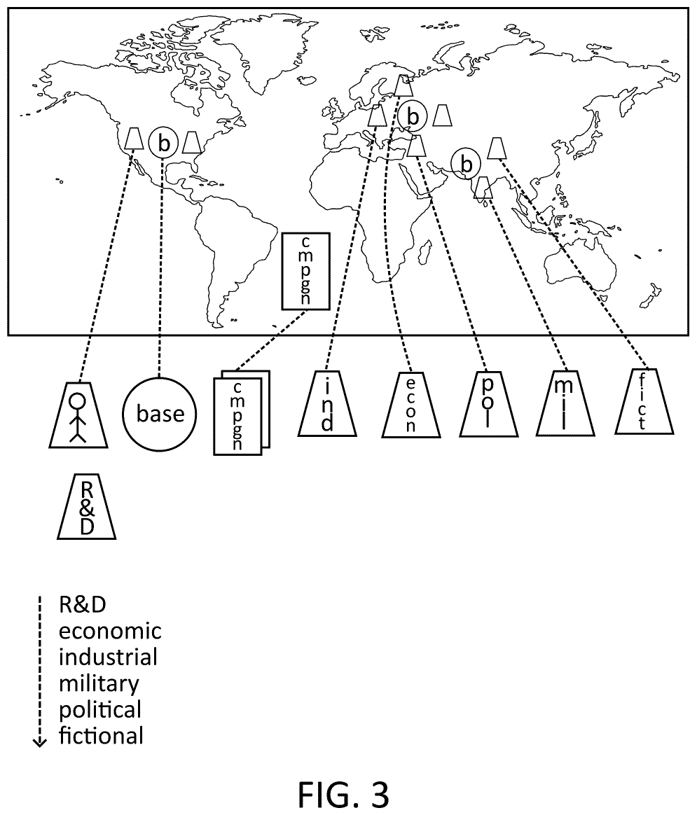

FIG. 3 is a game map including tokens and cards in accordance with an embodiment of the present disclosure. The tokens include a player token, an industry token, an economic token, a political token, a military token, a fictional token and a Research and Development R&D token. The cards include a base card and a campaign card which are placed on the world map according to the epoch the game is played in. Modes of play include peace mode, building mode, war mode and cold war mode.

The present disclosed the Real Time War Strategy Application Game, also known as “End of Days WW III”, introduces a modern war game app that employs unique concepts for strategy gaming set around the concept of the Cold War Era; yet, within a present-day setting. The End of Days WW III is intended to be compatible with all Android and iPhone devices and can be easily downloaded. Once installed, users can create an account and formalize their subscription access with the availability to purchase $4.99 packs and/or secure the $14.99 a month play option, in order to establish their General position.

In an embodiment, the game starts with the primary player being able to build their base, work on research to train troops, getting General experience and filling out their skill points as they proceed to access higher levels of the game. The overall objective is to max out the military base, employ strategy research, in addition to, fighting other players and competing in events to determine rank and high score winning history.

The End of Days WW III is designed to permit multiplayer or single player experiences and will utilize technological advancements to engage players in a rich mix of 2D and 3D graphics, varied low poly and detailed textures that further the real-world aesthetic.

Once players build up their base, they are able to work on research, build their troops and get their generals experience and fill out their skill points. The object is to max out base, research and generals plus fight other players and compete in events.

Conceptualization: Define the game's concept and overall vision, including the theme, setting, and goals. Gameplay mechanics: Define and refine the core game play mechanics, including army management, base building, and tactical battles. Accuracy: Research and incorporate accuracy into the game, including events, characters, and locations from the modern era and the chosen epoch. Base building: Design and implement the base building mechanics, including barracks, supply depots, and defensive structures.

Army management: Design and implement the army management mechanics, including recruiting, training, and upgrading soldiers and equipment. Tactical battles: Design and implement the tactical battle mechanics, including modern infantry, armored cavalry, artillery units, air and navy units, special ops and intelligence agency etc. Strategy planning: Design and implement the strategy planning mechanics, including terrain analysis, resource management, and unit positioning.

Campaign mode: Design and implement the campaign mode. Multiplayer mode: Design and implement the multiplayer mode, including both PVP and cooperative play options. Unit customization: Design and implement the unit customization mechanics, and assigning special abilities. Officer development: Design and implement the officer development mechanics, including increasing rank and abilities, and assigning them to lead different units.

Diplomacy: Design and implement the diplomacy mechanics, including negotiating with other players, forming alliances, and trading resources. Espionage: Design and implement the espionage mechanics, including sending spies to gather information on enemy forces. Technology tree: Design and implement the technology tree, including researching and unlocking new technologies. Historical events: Design and implement the historical events, including major battles, skirmishes, and political developments. Weather system: Design and implement the dynamic weather system, affecting visibility, mobility, and resource production. Terrain system: Design and implement the dynamic terrain system, affecting visibility, mobility, and resource production.

AI system: Design and implement the advanced AI system, allowing for intelligent and challenging opponents in both single and multiplayer modes. Replay ability: Ensure high replay ability through multiple campaign paths, multiplayer options, and random events. Real World authenticity: Ensure authenticity throughout the game as much as possible, with accurate representations of events, characters, and locations from the modern era.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A strategy game comprising: a world map comprising countries and cities and terrain of the world, past and present, according to a chosen game epoch; a plurality of base cards representing military bases including past and present and fictional according to the chosen epoch;
a plurality of player tokens representing military figures, past and present and fictional according to the chosen epoch; a plurality of campaign cards representing a particular battle documented from the chosen epoch and a fictional battle; a plurality of resource tokens each configured to represent a quanta of industrial strength, an economic strength, a political strength and a military strength and a fictional strength; a plurality of technology tokens each configured to represent a quanta of research and development strength of the particular military figure and his country and his epoch.

2. The strategy game of claim 1, wherein the game epochs include WW1 (world war 1), WW2 (world war 2), the Korean War between the US and China/Russia, the Vietnam war, the US war with Afghanistan, etc.

3. The strategy game of claim 1, wherein the military figures include Winston Churchill, Joseph Stalin, Franklin Delano Rosevelt, Adolf Hitler, Benito Mussolini, Charles de Gaulle, Harry S. Truman, Hirohito, Hideki Tojo, Chiang Kai-shek, Erwin Rommel, Omar Nelson Bradley, etc.

4. The strategy game of claim 1, wherein the military bases include Allied Bases and Axis Bases in Germany, Italy, Mediterranean and North Africa, Japan, East Asia and the Pacific Islands, Romania, Hungary and Bulgaria etc.,

5. The strategy game of claim 1, wherein the campaign cards include the Battle of Midway, the Battle of Iwo Jima, the Battle of the Bulge, the Battle of Leyte Gulf, the atomic bombings of Nagasaki and Hiroshima, the Normandy Landings, the Battle of Saipan, etc.

6. The strategy game of claim 1, wherein the quanta of industrial strength comprises number of armaments, units of steel manufacture, units of electrical power generated, units of aircraft manufactured etc within a cycle time.

7. The strategy game of claim 1, wherein the quanta of economic strength includes a gross domestic product (GDP), inflation of a currency and employment numbers and capacity for transportation of goods.

8. The strategy game of claim 1, wherein the quanta of political strength includes influence of a military figure on his contemporaries at home and abroad and a history of influence.

9. The strategy game of claim 1, wherein the quanta of military strength includes a country's military spending, number of weapons and military readiness and transportation capacity.

10. The strategy game of claim 1, wherein the quanta of research and development strength includes a measure of GDP invested in R&D activities and number of patents generated.

11. The strategy game of claim 1, further comprising a plurality of skill tokens earned in lesser amounts by skirmish victories and in larger amounts by battle victories and greater amounts by war victories.

12. The strategy game of claim 1, further comprising a predetermined number of resource tokens for a given player token and a given campaign card in a given epoch according to known world history.

13. The strategy game of claim 1, further comprising an earned number of resource tokens for a fictional player token for a given campaign in a given epoch.

14. The strategy game of claim 1, further comprising a mode of play including peace mode, cold war mode, building and training mode and war mode.

15. The strategy game of claim 1, wherein a game starts based on placement of the plurality of base cards on the world map and a placement of the plurality of player tokens and the plurality of campaign cards on the map.

16. The strategy game of claim 1, wherein a game commences based on an accumulation and a loss of the plurality of resource tokens exchanged by the plurality of player tokens according to a predetermined warfare.

17. The strategy game of claim 16, wherein the predetermined warfare is a hierarchy of value of the plurality of resource tokens based on one of a historical and chosen value for each of the industrial, economic, political, military and fictional strength.

18. The strategy game of claim 16, wherein war is declared based on a declaration of one of the plurality of player tokens on any another of the plurality of player tokens.

19. The strategy game of claim 16, further comprising a trump of a predetermined number of the plurality of resource tokens by a higher value of the plurality of R&D tokens.

20. The strategy game of claim 16, wherein the game ends based on a predetermined maximum of the plurality of base cards, a predetermined maximum of the plurality of resource tokens and a predetermined maximum of the plurality of R&D tokens held by a single player token of the plurality of player tokens.
